(19) United States
(12) Patent Application Publication
(10) Pub. No.: US 2004/0104202 A1
(43) Pub. Date: Jun. 3, 2004

(54) Laser scanning method and system for marking articles such as printed circuit boards, integrated circuits and the like

(75) Inventors: Joseph P. Downes, Belmont, MA (US); J. Miles Kane, Plaistow, NH (US); Frank B. Hunt JR., Shrewsbury, MA (US); Rainer Schramm, Everett, MA (US); Donald J. Svetkoff, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: GSI Lumonics, Inc., Kanata (CA)

(21) Appl. No.: 10/617,940

(22) Filed: Jul. 11, 2003

Related U.S. Application Data
(63) Continuation of application No. 10/019,522, filed on Apr. 15, 2002.
Application No. 10/019,522 is a 371 of international application No. PCT/US01/02354, filed on Jan. 25, 2001.
(60) Provisional application No. 60/178,814, filed on Jan. 28, 2000.

(51) Int. Cl. B23K 26/00

(52) U.S. Cl. 219/121.8; 219/121.82; 219/121.68; 347/224

(57) ABSTRACT

A laser scanning method and system for marking articles is provided wherein control is provided by a single central controller. The system includes a conveyor for conveying the articles in a first direction at a marking station. A conveyor controller controls the conveyor in response to conveyor control signals. A laser and an optical subsystem are optically coupled to the laser for generating a focused laser beam in response to laser control signals. A scan head includes a laser beam deflector for steering the focused laser beam along two substantially orthogonal intersecting axes at the marking station to mark a first predetermined region on at least one of the articles in response to deflection control signals. An actuator is coupled to at least part of the scan head for displacing the axes in a second direction substantially orthogonal to the first direction at the marking station in response to displacement control signals wherein the laser beam deflector steers the focused laser beam along the displaced axes to mark a second predetermined region on the at least one article. A central controller is provided for generating the deflection control signals, the laser control signals, the displacement control signals and the conveyor control signals in response to input data representing marking locations and marking content.

### TECHNICAL FIELD

This invention relates to laser scanning methods and systems for marking articles such as printed circuit boards, integrated circuits and the like. In particular, this invention relates to laser scanning methods and systems for high resolution marking of printed circuit boards, semiconductor packages such as micro-BGAs and CSPs, and similar articles at a marking station, for instance in an assembly line for an electronic manufacturing process. Typically the size of the region to be marked (the marking field) is substantially smaller than the substrate or device size wherein high definition machine and/or human readable marks are required.

### BACKGROUND OF THE INVENTION

PCB manufacturers, for instance producers of miniaturized telecommunication circuits, will provide increasing demand for internal and field failure tracking of circuits. Often the printed circuits are produced in panels where a multiplicity of identical circuits are present on a single panel or substrate called a “multi-up”—for instance a 2×3 arrangement of circuits in a “snap” assembly or on a pallet. Human and machine readable marks will be required—including two-dimensional cell codes, text, or barcodes. In other similar arrangements, articles may be present in a tray or container in a repetitive arrangement. For instance, multi-chip modules or die, or micro-BGAs (ball grid arrays) may be located in a repetitive arrangement in trays.

These manufacturers have a need for a flexible, economical, high-speed marking system. The marking system should be easily integrated into the production line, where conveyors are integral to the process. Marking speed must be sufficient to provide high definition marks in multiple regions without reducing production throughput. Cost and space savings are a plus.

A laser can mark information in small spaces and are matched to the trend where microelectronic assemblies and printed circuit boards are becoming smaller and denser. On high density circuit boards, for example, it may be necessary to mark a specified pattern, for instance a high density 2D cell code, in regions in close proximity to circuit patterns. This leads to a requirement of precision positioning of the marking beam.

Over the last two decades the laser marking industry has evolved and provides capability for marking metals to glass with the use of wavelengths from the Ultraviolet (about 355 nm) to the infrared (CO2 at 10.6 um).

The following representative references provide general information on laser markers:

Montagu, “Galvanometric and Resonant Low Inertia Scanners”, Laser Beam Scanning, Marcel-Dekker, 1985, pp 214-216;

Orlan Hayes, “Marking Applications now Encompass Many Materials”, Laser Focus World, Feb. 1997, pp 153-160; and

Brian Rossi, “Commercial Fiber Lasers Take on Industrial Markets”, LASER Focus WORLD, May 1997, pp 143-150.

The following are brief descriptions of US patents or PCT applications disclosing representative marking methods and systems:

WO 96/16767: A Marking Apparatus With Multiple Fibers Feeding a Plurality of Markers, Time Sharing;

WO 98/53949: Laser Marking and Energy Control W/a High Power Fiber Laser;

U.S. Pat. No. 5,965,042: Cleaning after Marking W/a Lower Energy Density Beam;

U.S. Pat. No. b 5,942,137: Laser Scribing of Grooves on Hard Crystals, the Crystals Are Positioned on an X,Y Stage and a Microscope Mounted on the Laser System;

U.S. Pat. No. 5,932,119: a Gemstone Micro-inscribing System with a Stage Displacing the Gemstone, and a Q-switched Laser System for Marking;

U.S. Pat. No. 5,719,372: a Q-switched Marking System W/a Controlled Pulse Width;

U.S. Pat. No. 5,690,846: a Laser Processing System W/X,Y Stages Moving the Object and a Pair of Mirrors Used to Mark;

U.S. Pat. No. 5,635,976: Writing Geometric Patterns on Photosensitive Substrates;

U.S. Pat. No. 5,600,478: a Laser Marker W/a Displaceable Mirror to Cause the Path of the Beam to Scan in One Direction, the Target Is Displaced in an Orthogonal Direction;

U.S. Pat. No. 5,521,628: Marking Multiple Regions Simultaneously, Diffractive Optics;

U.S. Pat. No. 5,357,077: System for Marking ICS Arranged in a Single File Tubular Holder W/Controlled Conveyor Positioning;

U.S. Pat. No. 5,329,090: Writing on Silicon W/a DPY Laser W/the Laser Beam Moved Across the Surface of the Wafer;

U.S. Pat. No. 4,985,780: a Portable Laser Engraving Machine with an X Carriage and Y Carriage for Positioning the Laser Beam for Engraving Selected Patterns;

U.S. Pat. No. 4,945,204: Marking Semiconductor Devices W/Specified Focused Energy Density and Pulse Duration;

U.S. Pat. No. 4,922,077: a Q-switched System for Marking Metal Packages with a 3 Step Process, Including Oscillating the Laser Beam in One Step;

U.S. Pat. No. 4,758,848: Marking a Pattern and Utilizing Partial Feedback of the Laser Beam;

U.S. Pat. No. 4,734,558: Laser Machining W/a Controlled Mask, for Instance an LCD;

U.S. Pat. No. 4,586,053: a Displayed Image Is Coupled to an LCD Which Is Then Controlled to Mark a Product;

U.S. Pat. No. 4,522,656: Wafer Marking W/Pulse Energy Control and Controlled Spot Size;

U.S. Pat. No. 4,323,755: Sequentially Vaporizing Contiguous Strips—Essentially a “Dot Matrix” Approach;

U.S. Pat. No. 4,220,842: Removing Material W/a CO2 Laser, Control Impulse Relative to the Expanding Plasma; and

U.S. Pat. No. 4,156,124: a Mask Arrangement for Engraving. Supporting Tables And/or the Laser Source Is Moved; Rotation Is Included.

Full field markers typically comprise a wide field optical scanner with a scan field sufficient to cover an entire “multi-up” or other part to be marked. A disadvantage is the low contrast marks on small printed circuit substrates for instance. With an increasing trend in miniaturization, for instance in the PCB industry where “multi-ups” are present, the full field approach is becoming increasingly deficient. Also, devices in tray pockets are emerging and are departing from traditional “gull wing” and QFP (quad flat pack) ICs and include micro BGAs and die where high resolution marks in restricted areas may be required.

In many marking systems, it is common to use a PLC (programmable logic controller) to run the conveyor, start the mark and run the conveyor. When the integration gets more sophisticated, such as SECS GEM software interfaces, these configurations are not as practical.

Prior art high resolution marking systems utilize x,y stages to displace the marking head or, alternatively, require loaders to position substrates on x,y stages for marking. This approach is generally more expensive. Furthermore, the use of loaders reduces throughput.

U.S. Pat. No. 5,847,960 discloses an apparatus and a method for positioning multiple tools, such as laser beams or other radiation beams, relative to target locations on multiple associated workpieces and, in particular, to a system that accurately coordinates the positioning of the multiple tools and associated target locations with a multi-stage, multi-head positioner.

### SUMMARY OF THE INVENTION

An object of one embodiment of the present invention is to provide a laser scanning method and system for marking articles such as printed circuit boards, integrated circuits and the like wherein a conveyor, a marker and a factory host interface are all controlled from a single software program.

In carrying out the above object and other objects of the present invention, a laser scanning method for marking articles is provided. The method includes the steps of: a) controllably conveying the articles in a first direction at a marking station; b) generating a focused laser beam; c) controllably steering the focused laser beam along two substantially orthogonal intersecting axes at the marking station to mark a first predetermined region on at least one of the articles based on input data representing marking locations and marking content; d) displacing the axes in a second direction substantially orthogonal to the first direction at the marking station; and e) controllably steering the focused laser beam along the displaced axes to mark a second predetermined region on the at least one article based on the input data.

The method may further include the steps of sensing at least one portion of the at least one article at the marking station and providing a corresponding signal representative of an image of the at least one portion and offsetting at least one of the axes prior to step c) based on the signal.

The articles may be substantially stationary, or may be controllably conveyed during step c).

The step of sensing may include the step of scanning a region of the at least one article containing a known feature of the at least one article and providing a corresponding image signal and offsetting at least one of the axes prior to step c) based on the image signal.

The articles may be printed circuit boards.

The articles may be integrated circuits, or may be semiconductor packages.

A marking pattern may include a plurality of spots, each having a size of about 25-50 microns, marked on each of the articles.

In further carrying out the above object and other objects of the present invention, a laser scanning system for marking articles is provided. The system includes a conveyor for conveying the articles in a first direction at a marking station. A conveyor controller controls the conveyor in response to conveyor control signals. A laser and an optical subsystem are optically coupled to the laser for generating a focused laser beam in response to laser control signals. A scan head includes a laser beam deflector for steering the focused laser beam along two substantially orthogonal intersecting axes at the marking station to mark a first predetermined region on at least one of the articles in response to deflection control signals. An actuator is coupled to at least part of the scan head for displacing the axes in a second direction substantially orthogonal to the first direction at the marking station in response to displacement control signals wherein the laser beam deflector steers the focused laser beam along the displaced axes to mark a second predetermined region on the at least one article. A central controller is provided for generating the deflection control signals, the laser control signals, the displacement control signals and the conveyor control signals in response to input data representing marking locations and marking content.

The system may further include a machine vision subsystem for sensing at least one portion of the at least one article at the marking station and providing a corresponding image signal representative of an image of the at least one portion, the central controller generating an offset signal in response to the image signal for offsetting at least one of the axes.

The machine vision subsystem may include a lighting assembly for illuminating the articles at the marking station.

The lighting assembly may include a pulsed illumination subsystem.

The laser beam deflector may include a two dimensional, addressable galvanometer.

The system may further include a second laser for generating a scanning laser beam. The laser beam deflector steers the scanning laser beam along the axes to scan a region of the at least one article containing a known feature of the at least one article and provides a corresponding image signal. The central controller generates an offset signal in response to the image signal for offsetting at least one of the axes.

The articles may be printed circuit boards.

The articles may be integrated circuits, or may be semiconductor packages.

A marking pattern may include a plurality of spots, each having a size of about 25-50 microns, marked on each of the articles.

The conveyor may be capable of being controllably positioned by the conveyor controller with a positioning accuracy of about 5 mils.

Objects of at least one embodiment of the invention also include:

Provide a laser scanning method and system for marking articles such as printed circuit boards, integrated circuits and the like.

Provide a laser marker which is “self contained” and is easily integrated into an automated manufacturing line, or alternatively could be operated in a stand-alone configuration.

Provide capability for high definition (high resolution) marks for either machine or human readability, high resolution 2D cell codes.

Provide high speed marking at production rates.

Provide a system which is capable of marking PCB substrates, conductor regions, and devices mounted on the board having many different material compositions through a selection of laser wavelengths and power.

Provide a system for “in-tray” marking of devices, including integrated circuit die, where high resolution marks are required in restricted, microscopic areas.

Provide an economical marking system where a conveyor provides sufficient positioning accuracy along the direction of substrate travel thereby eliminating the need for redundant positioning mechanisms and/or loaders.

Provide sufficiently accurate beam and substrate positioning capability, including machine vision-based registration, in the production line to allow for marking human or machine readable patterns in close proximity to circuit patterns including circuit patterns on die without the risk of circuit damage.

Provide a marking system where the marking content can be specified by the user on a “per-part” or “per-device” basis without providing a specification or directions for marking within the (x,y) global system and local scanner (x′,y′) coordinate system.

These objects are accomplished with the following method and system:

A method for high resolution marking of PCBs, integrated circuit packages, and devices and similar articles at a marking station. The method includes the steps of:

(1) Providing:

(a) a scan head comprising a beam scanner, a marking laser, a focusing system, and a predetermined maximum scan field for marking;

(b) a control system and a conveyor operatively connected to the control system for controllably positioning articles at at least one position within the marking station, the conveyor having a first direction of motion; and

(c) a translation mechanism for selectively positioning the scan head, the translation occurring along a second direction of motion;

(2) controllably positioning the article to a first location with the conveyor;

(3) marking a specified portion of the article by scanning the marking laser beam; and

(4) repeating the positioning and marking steps(2)-(3), respectively, until all specified portions of the article have been marked.

A system can be provided to perform each of the above steps. The conveyor can convey along an X-direction and the translation mechanism is controlled to move in a Y-direction substantially perpendicular to the X-direction.

Additionally the method and system may comprise at least the following steps or elements, respectively:

Scan head: a two dimensional addressable beam scanner generating a 2D pattern;

Translation mechanism: the mechanism may comprise a motorized single axis translator—which controllably translates the scan head in the at least a second direction of motion, the second direction may be substantially orthogonal to the first direction of conveyor motion;

Beam scanner: an addressable & programmable scanner, with raster/vector modes within the scan field;

Substrate or article: the substrate or article may be held stationary or may move during marking;

Laser: the laser is selected on the basis of laser-material interaction and may comprise (for instance) CO2, YAG, or a fiber laser. Frequency multiplication with non-linear crystals may be used to convert an IR wavelength to a visible wavelength. Wavelengths may be selected from the UV to IR. The laser may be a “MOPA” (master oscillator, power amplifier) configuration. These lasers and their operation are known to those skilled in the art;

Specified portion of the target: in each case may include multiple portions of the PCB “multi-up” or microscopic regions on IC packages, or die, for instance. The scan head may be indexed by the “single axis translator” to a plurality of marking locations along the “second direction of motion orthogonal to that of the conveyor”;

Scan Field: multiple locations may be marked within the marking field defined by the maximum scan field of the scanner, the marking occurring at a plurality of coordinates defined in the x′,y′ coordinate system, and optionally occurring while the scan head and conveyor are substantially stationary. The locations may be defined by a sequencing program which transfers x′,y′ coordinates for a plurality of regions from the control computer;

Sequencing Program: the sequencing program may determine from the process a sequence for rapid marking by accepting as inputs marking locations and marking content. The automatic sequencing program may output a control signal for positioning the marking head in the (x,y,x′,y′) coordinate system for marking an array of locations;

Scanning and marking step: may further comprise a registration step for automatically locating a known feature which is offset in translation and rotation from a specified region of the substrate to be marked;

The registration step may further comprise scanning a region containing the known feature w/the programmable scanner and adjusting the coordinates of the scanner for subsequent marking of the specified regions of the substrate;

The scan head may further comprise a low power laser used for scanning during the registration step. Alternatively, a vision system comprising a lighting and camera system may be provided; and

The registration step may occur while the substrate is in motion. If a camera based vision system is used the light may be strobed.

Further in carrying out the above objects and other objects of at least one embodiment of the present invention, a method is provided for controlling a PCB marker where a computer with a control program receives information about the content and location of marks, presence of objects to be marked and computes (or looks up) appropriate action sequences for the scanners, laser, conveyor and transverse gantry and causes them to be executed.

Still further in carrying out the above objects and other objects of at least one embodiment of the present invention, a system is provided with a target substrate, laser, scan head, focusing optics, conveyor for the x axis and transverse gantry for the y axis and a processing unit with a control program which marks at programmable locations on the target substrate.

There are other important elements:—for instance, marking software functions and the control function of the marking computer and laser power and pulse width control to produce high contrast marks.

The results are:

The scanner resolution may be high (i.e. large number of small, focused spots/field) for marking while maintaining speed and a small footprint.

Portions of the substrate, package, or die in close proximity to circuit elements may be marked with the improved accuracy without the risk of circuit damage.

The registration step allows for marking such regions where the marking region is tightly constrained.

Loaders, which would otherwise be required, are also eliminated with the benefit of cost reduction and throughput.

The above objects and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1a is a block diagram of a system constructed in accordance with the present invention wherein Y is the direction of motion of the scan head and X is the direction of motion of the conveyor;

FIG. 1b is a schematic perspective view, partially broken away, of a portion of the system of FIG. 1a and which shows representative marking field (total area) and specified regions on a “multi-up” PCB;

FIG. 1c is an exploded view of one of the specified regions of FIG. 1c and having a 2D code therein;

FIG. 1d is a top plan view of a PCB illustrating specified marking regions which show a typical 2D cell code;

FIG. 1e is a view similar to FIG. 1b without the conveyor wherein a box or container holds electronic devices separated by partitions;

FIG. 1f is a view similar to FIG. 1c;

FIGS. 2a-2d show the relative size of a scan field versus distance between specified regions, etc., wherein FIG. 2a shows a marking scan field greater than the substrate;

FIG. 2b shows a marking scan field which is not wide enough and head translation;

FIG. 2c shows a marking scan field which is wide enough for three substantially identical circuits conveyed on a conveyor;

FIG. 2d shows a general case of high resolution marking of multiple articles in accordance with the present invention, also showing conveyor motion and head translation where the X direction corresponds to motion of the head; and

FIG. 2e is a view similar to FIG. 2d except die are located in a tray.

### DESCRIPTION OF THE PREFERRED EMBODIMENT

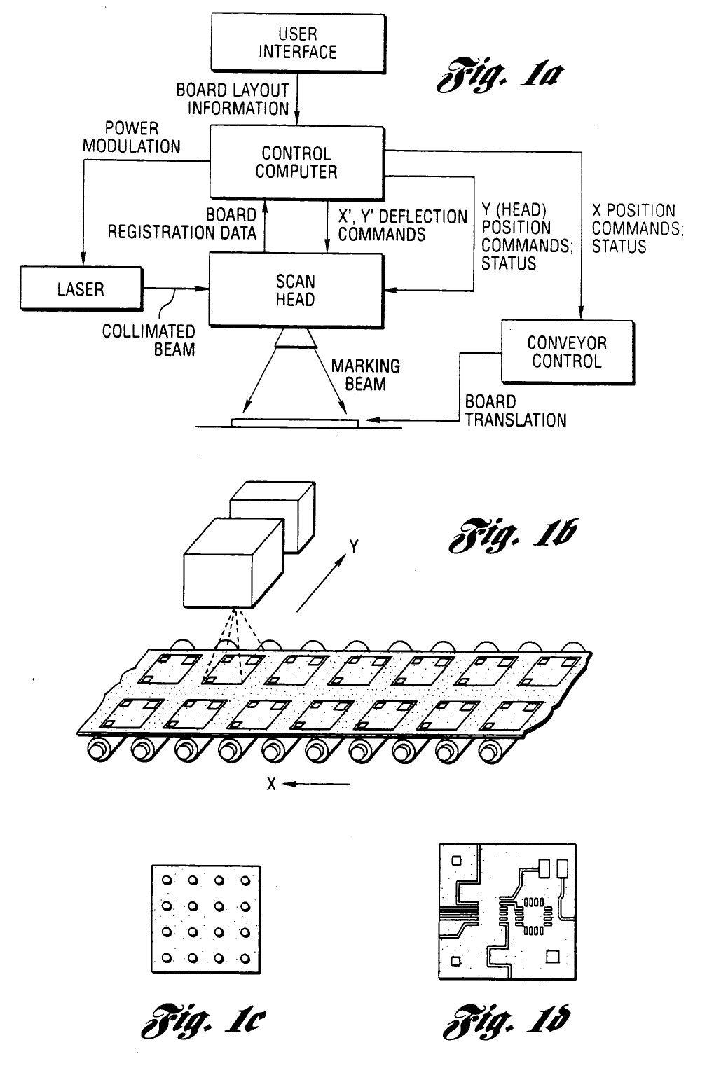

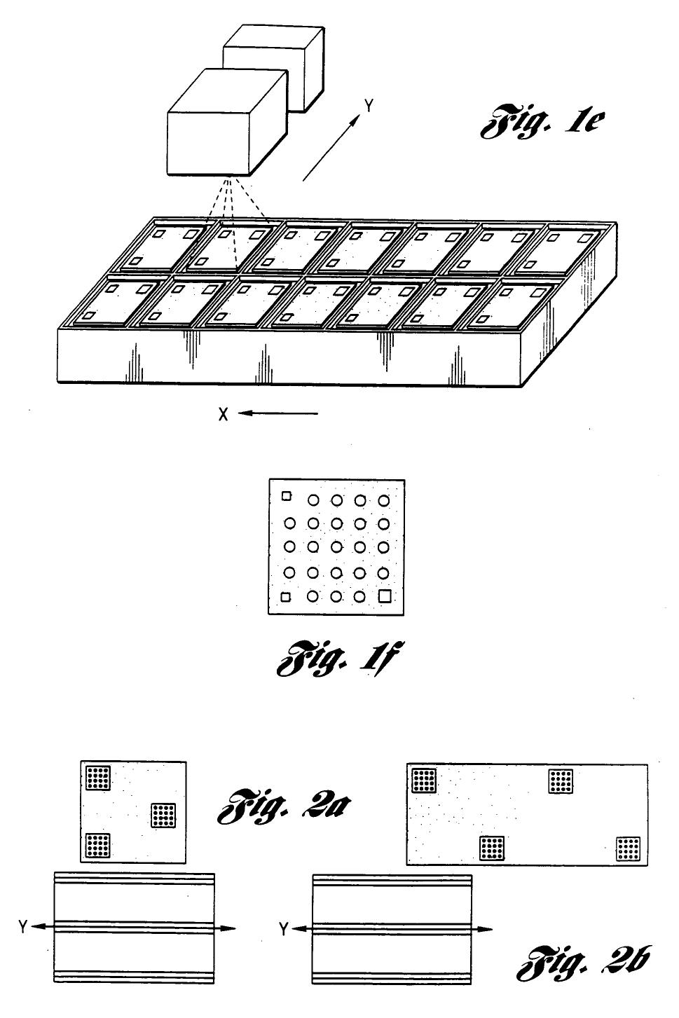

FIGS. 1a, 1b and 1e are illustrative diagrams of the preferred laser marking system. The marking system may be setup for operation either “in-line” or, alternatively, with stand-alone operation using PCB board stackers and de-stackers, or marking microscopic regions of devices in a tray, using try handlers. The system is preferably SMEMA assembly line compatible, a standard for software and mechanical interfaces.

In FIG. 1a the key elements of the system are shown.

In FIG. 1b a PCB represented as a 7×2 multi-up is shown on the conveyor system with a “marking field” (taken as the maximum scan field of the x′,y′ beam scanner—as measured on the board surface) covering a portion of the substrate. Full substrate coverage is obtained by translating the head in the y direction so as to position the scan head. The substrate is translated by the conveyor system along the x direction as needed. The information for a given substrate is supplied through the user interface and can be in the form of CAD data.

In FIG. 1d the relationship of the circuit patterns relative to specified regions for marking 2D cell codes is shown wherein FIG. 1c is an exploded view of one of the specified regions, in this case an element of a PCB “multi-up”.

LASER SYSTEM: Both CO2 and YAG designs are available for use, and fiber lasers are emerging, including visible wavelength models. These compact lasers provide several potential advantages. High contrast is often found with YAG and near IR lasers while CO2 material interaction often changes the color. UV solid state lasers are becoming more practical, though presently expensive, and may be used. The laser is also selected based upon the representative material and contrast requirements as described in the example below for circuit board materials.

| BOARD FINISH | LASER |
|---|---|
| Wet solder mask | CO2 |
| Dry solder mask | CO2 |
| Plating | YAG ,Fiber |
| Epoxy | YAG, Fiber, CO2 |
| Ink | YAG ,Fiber |
| Bare Board | CO2 |
| Other | To be Determined |

Other laser choices may be appropriate based upon the material optical properties and thermal sensitivity. These fundamental parameters, which are based upon the interaction of laser radiation with matter, will also influence or determine the choice of other system parameters such as the size of the marking field and spot size as will be further described below. In the preferred system the laser beam output is collimated and delivered to the scan head, or alternatively fiber coupled to the head.

SCAN HEAD: In a preferred embodiment for marking large substrates or microscopic regions of articles in a tray at high resolution a combination of marking head translation and beam is used. The inherent tradeoff between full field marking at low resolution and high resolution marking is mitigated by translation of the scan head, preferably in a direction orthogonal to the conveyor axis of motion. The use of X,Y galvanometer scanners for marking is well known in the art, c.f. Montagu, 1985 above, including a table showing marker performance parameters. In a preferred arrangement a pair of x,y mirrors (with coordinates of the associated marking beam defined in the x′,y′ coordinate system) are used to steer the laser beam under program control. Engrave, dot matrix, or wobble modes may be used as illustrated in this early prior art reference.

In the present invention the focusing lens must provide a spot size of about 25-50 microns typical over a scan field of about roughly 100 mm square (4 in.×4 in.). This corresponds to about 1:3000-1:6000 resolution. Larger marking fields can also be selected in certain cases, in some cases up to about 1:16000 or more. In any case, it is often desired to produce high resolution codes.

Design options are known to those skilled in the art and may include others types of beam deflectors. However, the addressability of the galvanometer approach along with sufficient speed for marking applications makes the X,Y mirror approach preferable. As indicated above, substrates where several regions must be marked require the scan head or a subset of scan head components be attached to a motion system for translation. Therefore, the scan head should be durable and compact.

CONTRAST DETERMINATION & CONTROL: Multiple compositions of FR4 material may impact laser mark contrast. Consequently, there is a high degree of variability in the micro-electronics area. As shown above, the laser choice is largely driven by the substrate parameters. “Bare boards” will vary in surface finish and plating, epoxy, and ink can affect the contrast. In the preferred system, the field size and spot size are specified as a function of the barcode or cell code to be marked. With barcodes the key parameter is the contrast on the material. With 2D cell codes the spot size and material interaction will drive the choice of the laser wavelength, power, and focused spot size. For text, human readability is important and will influence the choice of spot size. By way of example, the laser is selected as shown in the table above for marking printed circuit board materials.

MOTION AND SUBSTRATE POSITIONING SYSTEM: A key feature of the preferred system is the use of the conveyor to position the circuit board or similar article to a plurality of positions within the marking system while achieving a suitable level of accuracy and controlled motion in the orthogonal dimension with a high degree of accuracy. Also, in a preferred embodiment substrates having regions to be marked which are outside of the scan field are marked by positioning the scan head to a predetermined location for marking, either manually or automatically. The substrate is preferably positioned with a conveyor system typically providing positioning accuracy of about +−5 mils (+−125 um) while handling a wide range of printed circuit board thickness specifications. In a preferred embodiment, the conveyor is about 1 m in length and can handle boards having lengths from about 75 mm-500 mm. The system will also include either automatic or manual adjustment of the height of the marking head relative to the conveyor. In the case where semiconductor devices in a tray are marked at high resolution, semiconductor die having tight requirements may be semi-constrained.

MARKING OPERATION: Substrates to be marked typically range from single miniature circuits to 500 mm×500 mm substrates with a “multi-up” arrangement. Alternatively, a tray may contain several die in a typical 100 mm×200 mm region. The following specific arrangements will further illustrate the operation of the system:

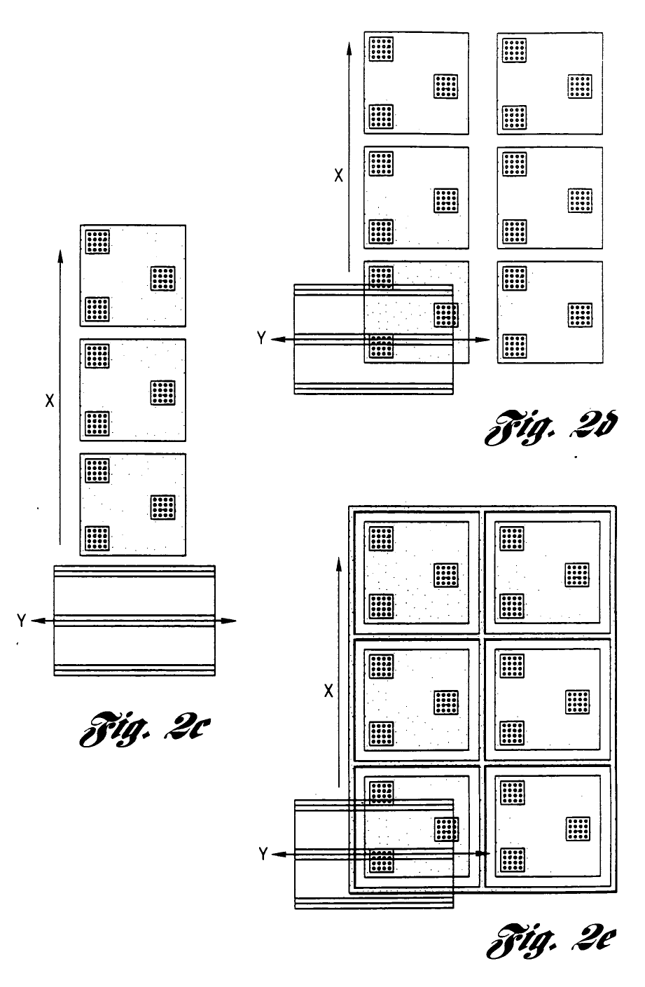

In the simplest configuration the scan field, typically 100 mm×100 mm, will be sufficiently large to mark any specified region without motion of the head. The head may be manually positioned to compensate for offsets associated with different circuit board layouts and structures (FIG. 2a).

In a second configuration of FIG. 2c, a 3×1 multi-up, for example, the marking field is sufficient to cover the width of the PCB substrate. The conveyor is used to index the substrate in a “step and repeat” manner along a first direction. The x′,y′ scanning action then preferably marks all regions addressable within the scan field. No motion of the scan head is required. After the marking of this region is complete the conveyor indexes to another location.

In a third configuration shown in FIG. 2b, a substrate is positioned with the conveyor with the narrow dimension within the marking field but having a width which exceeds the marking field in a direction orthogonal to the conveyor motion. In this case the regions of the substrate are marked which are within the addressable scan field, and then the marking head is translated in a direction orthogonal to the conveyor.

Finally, a fourth method of general operation is illustrated in FIG. 2d. The conveyor positions the board and all substrate locations are marked for a fixed conveyor position by translating the head to predetermined positions and then marking with the x′y′ scanning action. Then the conveyor is indexed and the process is repeated.

FIG. 2e shows a similar arrangement where a large number of die are present. The devices are in a compartmental tray. In this case, a smaller marking field may be advantageous with vision-aided location and registration of the devices. The region to be marked may require precise positioning of the laser beam.

REGISTRATION: During the marking steps it is necessary to identify the proper sections of the substrate where the marking is to occur. This can be of critical importance if circuitry is adjacent to the specified marking region, a characteristic of emerging high density PCB layouts. If the laser beam positioning is to be precise to avoid damage to circuit areas in close proximity it may be necessary to identify circuit features which may be traces, id marks, or fiducials and offset the scan positions accordingly prior to marking with the high power laser. In one embodiment the substrate is scanned with a optical sensor disjoint from the scan head to locate the board position while the circuit board is moved into the system. In a preferred embodiment for precision beam positioning a low power laser beam may transmitted through the scan head and scans a region of the circuit board. Retro-reflected energy is sensed through the optical system and subsequently digitized to locate circuit features from which scanner offsets are calculated. Alternatively, a similar operation may be performed with a separate vision system. In the case of a moving substrate it is preferable that a pulsed illumination system be used, for instance an array of controlled LEDs, to produce high contrast images.

MARK VERIFICATION: A mark reader, such as a simple 2D cell code reader may be provided and may be attached to the scan head.

These configurations and illustrations are intended to describe typical embodiments but should not be considered restrictive.

While the best mode for carrying out the invention has been described in detail, those familiar with the art to which this invention relates will recognize various alternative designs and embodiments for practicing the invention as defined by the following claims.

What is claimed is:

1. A laser scanning method for marking articles, the method comprising:
a) controllably conveying the articles in a first direction at a marking station;
b) generating a focused laser beam;
c) controllably steering the focused laser beam along two substantially orthogonal intersecting axes at the marking station to mark a first predetermined region on at least one of the articles based on input data representing marking locations and marking content;
d) displacing the axes in a second direction substantially orthogonal to the first direction at the marking station; and
e) controllably steering the focused laser beam along the displaced axes to mark a second predetermined region on the at least one article based on the input data.

2. The method as claimed in claim 1 further comprising the steps of sensing at least one portion of the at least one article at the marking station and providing a corresponding signal representative of an image of the at least one portion and offsetting at least one of the axes prior to step c) based on the signal.

3. The method as claimed in claim 1 wherein the articles are substantially stationary during step c).

4. The method as claimed in claim 1 wherein the articles are controllably conveyed during step c).

5. The method as claimed in claim 2 wherein the step of sensing includes the step of scanning a region of the at least one article containing a known feature of the at least one article and providing a corresponding image signal and offsetting at least one of the axes prior to step c) based on the image signal.

6. The method as claimed in claim 1 wherein the articles are printed circuit boards.

7. The method as claimed in claim 1 wherein the articles are integrated circuits.

8. The method as claimed in claim 1 wherein the articles are semiconductor packages.

9. The method as claimed in claim 1 wherein a marking pattern including a plurality of spots, each having a size of about 25-50 microns, is marked on each of the articles.

10. A laser scanning system for marking articles, the system comprising:
a conveyor for conveying the articles in a first direction at a marking station;
a conveyor controller for controlling the conveyor in response to conveyor control signals;
a laser and an optical subsystem optically coupled to the laser for generating a focused laser beam in response to laser control signals;
a scan head including a laser beam deflector for steering the focused laser beam along two substantially orthogonal intersecting axes at the marking station to mark a first predetermined region on at least one of the articles in response to deflection control signals;
an actuator coupled to at least part of the scan head for displacing the axes in a second direction substantially orthogonal to the first direction at the marking station in response to displacement control signals wherein the laser beam deflector steers the focused laser beam along the displaced axes to mark a second predetermined region on the at least one article; and
a central controller for generating the deflection control signals, the laser control signals, the displacement control signals and the conveyor control signals in response to input data representing marking locations and marking content.

11. The system as claimed in claim 10 further comprising a machine vision subsystem for sensing at least one portion of the at least one article at the marking station and providing a corresponding image signal representative of an image of the at least one portion, the central controller generating an offset signal in response to the image signal for offsetting at least one of the axes.

12. The system as claimed in claim 11 wherein the machine vision subsystem includes a lighting assembly for illuminating the articles at the marking station.

13. The system as claimed in claim 12 wherein the lighting assembly includes a pulsed illumination subsystem.

14. The system as claimed in claim 10 wherein the laser beam deflector includes a two dimensional, addressable galvanometer.

15. The system as claimed in claim 10 further comprising a second laser for generating a scanning laser beam, the laser beam deflector steering the scanning laser beam along the axes to scan a region of the at least one article containing a known feature of the at least one article and providing a corresponding image signal, the central controller generating an offset signal in response to the image signal for offsetting at least one of the axes.

16. The system as claimed in claim 10 wherein the articles are printed circuit boards.

17. The system as claimed in claim 10 wherein the articles are integrated circuits.

18. The system as claimed in claim 10 wherein the articles are semiconductor packages.

19. The system as claimed in claim 10 wherein a marking pattern including a plurality of spots, each having a size of about 25-50 microns, is marked on each of the articles.

20. The system as claimed in claim 10 wherein the conveyor is capable of being controllably positioned by the conveyor controller with a positioning accuracy of about 5 mils.
